(19) United States
(12) Patent Application Publication
(10) Pub. No.: US 2016/0091870 A1
(43) Pub. Date: Mar. 31, 2016

(54) REDUNDANCY-READY CONTROL APPARATUS, REDUNDANCY SYSTEM AND METHOD FOR CONFIGURING REDUNDANT LOGICS FOR ASSURING LOW POWER CONSUMPTION AND RELIABILITY AT THE SAME TIME

(71) Applicant: RESEARCH & BUSINESS FOUNDATION SUNGKYUNKWAN UNIVERSITY, Suwon-si (KR)

(72) Inventors: Jae Wook JEON, Seoul (KR); Jin Ho KIM, Suwon-si (KR); Jong Doo PARK, Suwon-si (KR); Yong Seo LEE, Daejeon (KR); Chae Hong YI, Ulsan (KR)

(73) Assignee: RESEARCH & BUSINESS FOUNDATION SUNGKYUNKWAN UNIVERSITY, Suwon-si (KR)

(21) Appl. No.: 14/865,246

(22) Filed: Sep. 25, 2015

(30) Foreign Application Priority Data
Sep. 26, 2014 (KR) 10-2014-0129297

(51) Int. Cl. G05B 9/03

(52) U.S. Cl. CPC G05B 9/03

(57) ABSTRACT

A redundancy-ready control apparatus, a redundancy system, and a method for configuring redundant logics are disclosed. The redundancy-ready control apparatus includes a plurality of function blocks, a redundancy configuration determining unit, a function block activating unit, and a synchronizing unit. The plurality of function blocks respectively performs a predetermined function. The redundancy configuration determining unit determines function blocks to be included in a redundancy configuration based on the priorities of the respective function blocks. According to the redundancy configuration, the function block activating unit activates the function blocks corresponding to the redundancy configuration to connect power and operational clocks to the activated function blocks, or deactivates function blocks excluded from the redundancy configuration to disconnect power or operational clocks to the deactivated function blocks. The synchronizing unit synchronizes each of the function blocks of the redundancy configuration with a function block that performs an identical redundant function.

### CROSS-REFERENCE TO RELATED APPLICATION(S)

This application claims the benefit under 35 USC 119(a) of Korean Patent Application No. 10-2014-0129297 filed on Sep. 26, 2014 in the Korean Intellectual Property Office, the entire disclosure of which is incorporated herein by reference for all purposes.

### BACKGROUND

1. Field

The present invention relates generally to redundancy technique, and more particularly to redundancy technique for ensuring both low power consumption and reliability.

2. Description of the Related Art

In general, a redundancy system, in a field requiring high reliability or constant operation, refers to a system in which a plurality of apparatuses is prepared for each important function and is made to perform the same task at the same time, or a system in which the overall system is separated into a primary apparatus and an auxiliary apparatus or into a primary apparatus and a backup apparatus so that the apparatuses are made to perform different tasks.

In particular, a monitoring and control system is generally based on a high-performance Central Processing Unit (CPU) and input and output logics. Since the monitoring and control system attempts to achieve both high performance and low power consumption, there is a tendency for clock speed to increase and for operation voltage to decrease. Accordingly, threshold voltage decreases and a noise margin becomes strict, and thus the possibility of both major and minor temporary errors, attributable to various types of noise, increases.

In the redundancy system using a method in which a plurality of apparatuses performs the same task at the same time, a temporary error can be corrected based on results obtained from the plurality of apparatuses, by a majority rule using, for example, a voting technique. However, in view of the fact that the voting technique based on a majority rule requires at least three sets of duplicate systems, this method is unreasonable in terms of cost and power consumption.

The redundancy system using a method of assigning different roles to a plurality of apparatuses distributes loads among the individual apparatuses, and, as a result, can improve reliability. However, when a temporary error is present in data created by each of the apparatuses, it is difficult to detect and correct the error using another apparatus.

### SUMMARY

The present invention is directed to the provision of a redundancy-ready control apparatus, a redundancy system, and a method for configuring redundant logics that can ensure both low power consumption and reliability.

The present invention is directed to the provision of a redundancy-ready control apparatus, a redundancy system, and a method for configuring redundant logics that can ensure reliability because they can detect and correct a temporary error using a plurality of apparatuses that perform the same task at the same time, and that also can reduce power that is consumed by a plurality of apparatuses.

In accordance with an aspect of the present invention, there is provided a redundancy-ready control apparatus, including: a plurality of function blocks each configured to perform a predetermined function; a redundancy configuration determining unit configured to determine function blocks, which will be included in a redundancy configuration, based on priorities assigned to the respective function blocks; a function block activating unit configured to, according to the redundancy configuration, activate the function blocks included in the redundancy configuration to connect power and operational clocks to the activated function blocks, or deactivate one or more function blocks excluded from the redundancy configuration to disconnect power or operational clocks to the deactivated function blocks; and a synchronizing unit configured to synchronize each of the function blocks, included in the redundancy configuration, with a function block that performs an identical redundant function in another redundancy-ready control apparatus.

The redundancy-ready control apparatus may further include a result output unit configured to compare the operation result of each of the function blocks, included in the redundancy configuration, with the operation result of a function block that performs an identical redundant function in another redundancy-ready control apparatus, to correct the operation results, and to output the corrected operation results.

In accordance with another aspect of the present invention, there is provided a redundancy system including a microprocessor, memory, and a plurality of redundancy-ready control apparatuses, wherein each of the redundancy-ready control apparatus includes: a plurality of function blocks each configured to perform a predetermined function; a redundancy configuration determining unit configured to determine function blocks, which will be included in a redundancy configuration, based on priorities assigned to the respective function blocks; a function block activating unit configured to, according to the redundancy configuration, activate the function blocks included in the redundancy configuration connect power and operational clocks to the activated function blocks, or deactivate one or more function blocks excluded from the redundancy configuration to disconnect power or operational clocks to the deactivated function blocks; and a synchronizing unit configured to synchronize each of the function blocks, included in the redundancy configuration, with a function block that performs an identical redundant function in another redundancy-ready control apparatus.

The redundancy-ready control apparatus may further include a result output unit configured to compare the operation result of each of the function blocks, included in the redundancy configuration, with the operation result of a function block that performs an identical redundant function in another redundancy-ready control apparatus, to correct the operation results, and to output the corrected operation results.

The microprocessor may be operative to compare and correct the operation results of the function blocks of the redundancy-ready control apparatuses that perform redundant functions.

The microprocessor may be operative to record information about a function block and a redundancy-ready control apparatus, which belong to the function blocks, included in the redundancy configuration, and the redundancy-ready control apparatuses and which have generated an error, in the memory.

In accordance with still another aspect of the present invention, there is provided a method for configuring redundant logics for a redundancy system including redundancy-ready control apparatuses, each including a plurality of function blocks each configured to perform a predetermined function, and a microprocessor, the method including: by the redundancy-ready control apparatus: determining function blocks, which will be included in a redundancy configuration, based on priorities assigned to the respective function blocks; according to the redundancy configuration, activating the function blocks included in the redundancy configuration to connect power and operational clocks to the activated function blocks, or deactivating one or more function blocks excluded from the redundancy configuration to disconnect power or operational clocks to the deactivated function blocks; and synchronizing each of the function blocks, included in the redundancy configuration, with a function block that performs an identical redundant function in another redundancy-ready control apparatus.

The method may further include: by the redundancy-ready control apparatus: comparing the operation result of each of the function blocks, included in the redundancy configuration, with the operation result of a function block that performs an identical redundant function in another redundancy-ready control apparatus, correcting the operation results, and outputting the corrected operation results.

The method may further include: by the microprocessor: comparing and correcting the operation results of the function blocks of the redundancy-ready control apparatuses that perform redundant functions.

In accordance with yet another aspect of the present invention, there is provided a computer program stored in a non-transitory computer-readable storage medium to execute, in a computer, the steps of the method for configuring redundant logics for a redundancy system.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram illustrating redundancy-ready control apparatuses and a redundancy system including the redundancy-ready control apparatuses according to an embodiment of the present invention; and

FIG. 2 is a flowchart showing a method for configuring redundant logics an embodiment of according to the present invention.

### DETAILED DESCRIPTION

As for embodiments of the present invention disclosed herein, specific structural and functional descriptions are given merely for the purpose of illustrating the embodiments of the present invention. Embodiments of the present invention may be practiced in various forms, and the present invention should not be construed as being limited to the embodiments disclosed herein.

Embodiments of the present invention will be described in detail below with reference to the accompanying drawings. The same reference numerals will be used to denote the same components throughout the accompanying drawings, and redundant descriptions of the same components will be omitted.

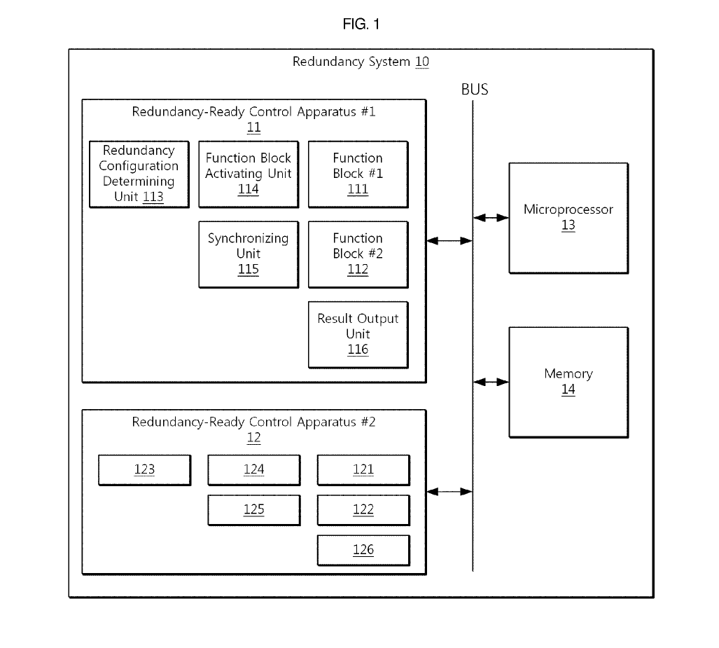

FIG. 1 is a conceptual diagram illustrating redundancy-ready control apparatuses and a redundancy system 10 including the redundancy-ready control apparatuses according to an embodiment of the present invention.

Referring to FIG. 1, the redundancy system 10 according to the present embodiment includes a plurality of redundancy-ready control apparatuses 11 and 12, a microprocessor 13, and memory 14.

Each of the plurality of redundancy-ready control apparatuses 11 and 12 includes function blocks that have hardware specifications substantially identical to those of the other apparatus, or includes function blocks that perform functions identical to those of the other apparatus even when the function blocks have hardware configurations different from those of the other apparatus. Accordingly, the plurality of redundancy-ready control apparatuses 11 and 12 may be configured according to an appropriate redundancy configuration based on predetermined redundancy methods, such as a method of performing the same operation in different pieces of hardware, detecting an error, and verifying it or a method of undertaking the role of a primary apparatus and the role of an auxiliary/backup apparatus from each other.

Each of the redundancy-ready control apparatuses 11 and 12 may include function blocks 111 and 112, or 121 and 122, a redundancy configuration determining unit 113 or 123, a function block activating unit 114 or 124, and a synchronizing unit 115 or 125, and may further include a result output unit 116 or 126 according to an embodiment.

Each of the plurality of function blocks 111, 112, 121 and 122 is a circuit block, such as a logic circuit, an input/output circuit, an analog-digital conversion circuit, a digital-analog conversion circuit, memory, a register, a cache or the like, which is designed to perform a predetermined function.

A redundancy priority is assigned to each of the function blocks 111, 112, 121 and 122 based on the level of reliability of a corresponding function required in the redundancy system 10. A redundancy priority that increases in proportion to the level of reliability of a function that is performed by each of the function blocks 111, 112, 121 and 122 may be assigned by a designer or a user. For example, since basically at least one function block that operates for the purpose of performing each function needs to be present in the redundancy system 10, the function blocks 111 and 112 of any one redundancy-ready control apparatus 11 are assigned higher redundancy priorities. In contrast, the function blocks 121 and 122 of the other redundancy-ready control apparatus 12 may be assigned appropriate redundancy priorities according to the intention of a designer or a user. For example, when higher reliability is required for a first function, the function block 121 is assigned a higher priority so that it can perform a redundancy operation along with the function block 111. In contrast, if a second function does not require higher reliability and it is sufficient for the function block 112 to operate single-handedly, the function block 122 performing the second function will be assigned a lower priority.

These redundancy priorities may be stored in the redundancy-ready control apparatuses 113 and 123 or in the redundancy system 11 by a designer or a user.

The redundancy configuration determining units 113 and 123 select function blocks (for example, the function blocks 111, 112 and 121), which will be included in a redundancy configuration, among the function blocks 111, 112, 121 and 122 of the corresponding redundancy-ready control apparatuses 11 and 12 based on the priorities assigned to the respective function blocks 111, 112, 121 and 122.

According to the determined redundancy configuration, the function block activating units 114 and 124 may operate to initialize and activate the function blocks 111, 112 and 121 included in the redundancy configuration and to connect power and operational clocks to the activated function blocks 111, 112 and 121, or may operate to deactivate the function block 122 excluded from the redundancy configuration and to disconnect power or operational clocks to the deactivated function block 122.

Meanwhile, since the activated function blocks 111, 112 and 121 separately operate in the corresponding redundancy-ready control apparatus 11 or 12, the synchronization of the operations of inputting and outputting various types of signals and the synchronization of computational operations required for redundancy are not guaranteed yet, even though the activated function blocks operate under synchronized operational clocks.

Accordingly, the synchronizing units 115 and 125 may synchronize the function block 111 or 121 included in the redundancy configuration of the corresponding redundancy-ready control apparatus 11 or 12 with the function block 121 or 111 that performs redundant function in the other redundancy-ready control apparatus 12 or 11.

Once the synchronization of the functions has been also achieved, the redundancy- ready control apparatuses 11 and 12 may perform redundancy operations required for the redundancy system 10.

Meanwhile, in an embodiment, each of the redundancy-ready control apparatuses 11 and 12 may further include a result output unit 116 or 126.

The result output units 116 and 126 may compare the operation result of the function block 111 included in the redundancy configuration of any one redundancy-ready control apparatus 11 with the operation result of the function block 121 that performs the same redundant function in the other redundancy-ready control apparatus 12, may correct the operation results if the two operation results are different, and may output the corrected operation results to the microprocessor 13 or memory 14 of the redundancy system 10.

Meanwhile, the correction of the operation result may be performed by the microprocessor 13.

In this case, the microprocessor 13 may compare the operation results of the function blocks 111 and 121 that perform the same redundant function in the corresponding redundancy-ready control apparatuses 11 and 12, and then may correct the operation results.

Whichever case that the operation results are corrected by the redundancy-ready control apparatuses 11 and 12, or microprocessor 13, the microprocessor 13 records information, in the memory 14, concerning a function block and a redundancy-ready control apparatus that have caused an error.

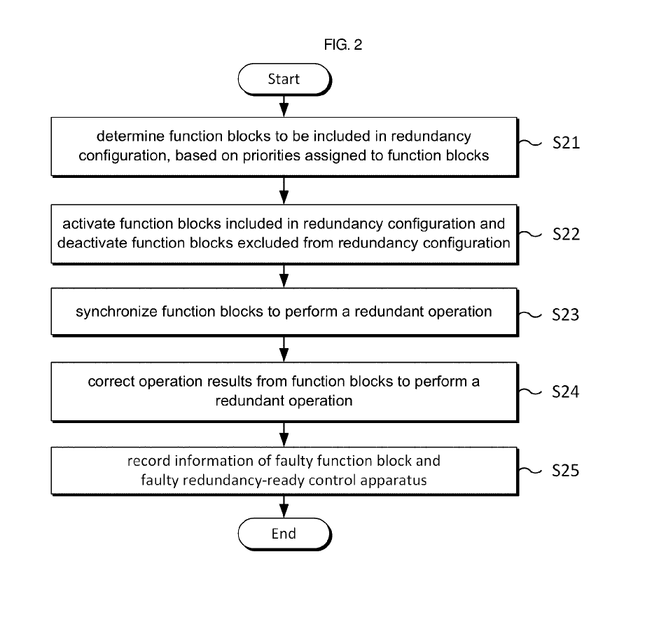

FIG. 2 is a flowchart showing a method for configuring redundant logics an embodiment of according to the present invention.

Referring to FIG. 2, the method for configuring redundant logics according to the present embodiment invention is a method for configuring redundant logics performed in the redundancy system including the redundancy-ready control apparatuses 11 and 12, each including a plurality of function blocks 111 and 112, or 121 and 122 that performed respective predetermined functions, and the microprocessor 13. The method for configuring redundant logics according to the present embodiment starts with step S21.

At step S21, the redundancy-ready control apparatuses 11 and 12 determine function blocks (for example, the function blocks 111, 112, and 121) to be included in a redundancy configuration, based on priorities assigned to the respective function blocks 111, 112, 121 and 122.

More specifically, the more the reliability of a function that each of the function blocks 111, 112, 121, 122 performs is necessary, the higher the redundancy priority may be assigned to each of the function blocks 111, 112, 121, 122 by a designer or a user.

Thereafter, at step S22, according to the determined redundancy configuration, the function block activating units 114 and 124 may operate to initialize and activate the function blocks 111, 112 and 121 included in the redundancy configuration and to connect power and operational clocks to the activated function blocks 111, 112 and 121, or may operate to deactivate the function block 122 excluded from the redundancy configuration and to disconnect power or operational clocks to the deactivated function block 122.

At step S23, for each of the function blocks 111, 121 included in the redundancy configuration, the redundancy-ready control apparatus 11 may synchronize the function block 111 with the function block 121 to perform a redundant operation in the other redundancy-ready control apparatus 12.

At step S24, the redundancy-ready control apparatus 11 may compare the operation result of the function block 111 included in the redundancy configuration with the operation result of the function block 121 that performs a redundant function in the other redundancy-ready control apparatus 12, and if needed, may correct the operation results, so as to output the corrected operation results.

Meanwhile, in an embodiment, the operation of step S24 may be performed by the microprocessor 13, other than the redundancy-ready control apparatus 11.

In this case, the microprocessor 13 may receive the operation results of the function blocks 111 and 121 of the redundancy-ready control apparatuses 11 and 12 that perform the same redundant function, may compare the operation results, and then may correct the operation results.

Furthermore, at step S25, the microprocessor 13 may record information, in the memory, about any faulty function block and any faulty redundancy-ready control apparatus that have caused an error.

The redundancy-ready control apparatus, the redundancy system, and the method for configuring redundant logics according to the present invention can ensure both low power consumption and reliability.

More specifically, the redundancy-ready control apparatus, the redundancy system, and the method for configuring redundant logics according to the present invention can ensure reliability because they can detect and correct a temporary error using a plurality of apparatuses that perform the same task at the same time, and also can reduce power that is consumed by a plurality of apparatuses.

The above embodiments and the accompanying drawings are intended merely to clearly illustrate part of the technical spirit of the present invention, and it will be apparent to those skilled in the art that modifications and specific embodiments that those skilled in the art can easily derive from the present specification and the accompanying drawings are all included in the range of the rights of the present invention.

Furthermore, the apparatus according to the present invention may be implemented as computer-readable code that is stored in computer-readable storage medium. The computer-readable storage medium includes all types of storage device in which computer system-readable data can be stored. Examples of the storage medium include read only memory (ROM), random access memory (RAM), optical disks, magnetic tape, floppy disks, hard disks, nonvolatile memory, etc. Furthermore, the computer-readable storage medium may be distributed among computer systems connected over a network so that computer-readable code can be stored and executed in a distributed manner.

What is claimed is:

1. A redundancy-ready control apparatus, comprising:
a plurality of function blocks each configured to perform a predetermined function;
a redundancy configuration determining unit configured to determine which function block should be included in a redundancy configuration, based on priorities assigned to the function blocks;
a function block activating unit configured to, according to the redundancy configuration, activate the function blocks included in the redundancy configuration to provide power and operational clocks to the activated function blocks, or deactivate one or more function blocks excluded from the redundancy configuration to disconnect power or operational clocks to the deactivated function blocks; and
a synchronizing unit configured to synchronize any function block included in the redundancy configuration, to another function block that performs an identical redundant function in another redundancy-ready control apparatus.

2. The redundancy-ready control apparatus of claim 1, further comprising a result output unit configured to compare an operation result of any function block, included in the redundancy configuration, with another operation result of another function block that performs an identical redundant function in another redundancy-ready control apparatus, to correct the operation results, and to output the corrected operation result.

3. A redundancy system comprising a microprocessor, a memory, and a plurality of redundancy-ready control apparatuses, wherein each of the redundancy-ready control apparatus comprises:
a plurality of function blocks each configured to perform a predetermined function;
a redundancy configuration determining unit configured to determine which function block should be included in a redundancy configuration, based on priorities assigned to the function blocks;
a function block activating unit configured to, according to the redundancy configuration, activate the function blocks included in the redundancy configuration to connect power and operational clocks to the activated function blocks, or deactivate one or more function blocks excluded from the redundancy configuration to disconnect power or operational clocks to the deactivated function blocks; and
a synchronizing unit configured to synchronize any function block, included in the redundancy configuration, with another function block that performs an identical redundant function in another redundancy-ready control apparatus.

4. The redundancy system of claim 3, wherein the redundancy-ready control apparatus further comprises a result output unit configured to compare an operation result of any function block included in the redundancy configuration, with another operation result of another function block that performs an identical redundant function in another redundancy-ready control apparatus, to correct the operation results, and to output the corrected operation result.

5. The redundancy system of claim 3, wherein the microprocessor is operative to compare and correct operation results of function blocks of the redundancy-ready control apparatuses that perform redundant functions.

6. The redundancy system of claim 3, wherein the microprocessor is operative to record information, in the memory, about faulty function blocks and faulty redundancy-ready control apparatuses among the function blocks and redundancy-ready control apparatuses included in the redundancy configuration.

7. A method for configuring redundant logics for a redundancy system including redundancy-ready control apparatuses, each including a plurality of function blocks each configured to perform a predetermined function, and a microprocessor, the method comprising:
determining, by the redundancy-ready control apparatus, which function block should be included in a redundancy configuration, based on priorities assigned to the function blocks;
activating, by the redundancy-ready control apparatus, according to the redundancy configuration, the function blocks included in the redundancy configuration to connect power and operational clocks to the activated function blocks, or deactivating one or more function blocks excluded from the redundancy configuration to disconnect power or operational clocks to the deactivated function blocks; and
synchronizing any function block included in the redundancy configuration, with another function block that performs an identical redundant function in another redundancy-ready control apparatus.

8. The method of claim 7, further comprising:
comparing, by the redundancy-ready control apparatus, an operation result of any function block included in the redundancy configuration, with another operation result of another function block that performs an identical redundant function in another redundancy-ready control apparatus, correcting the operation results, and outputting the corrected operation result.

9. The method of claim 8, further comprising:
comparing and correcting, by the microprocessor, operation results of function blocks of the redundancy-ready control apparatuses that perform redundant functions.

10. A non-transitory computer-readable storage medium having stored thereon computer program instructions that, when executed by a processor, cause the processor to execute the method set forth in claim 7.
